(19) United States
(12) Patent Application Publication
(10) Pub. No.: US 2020/0247988 A1
(43) Pub. Date: Aug. 6, 2020

(54) CONTAINER FOR CHLORINE-BASED LIQUID BLEACHING AGENT COMPOSITION, AND BLEACHING AGENT ARTICLE

(71) Applicant: Mitsubishi Gas Chemical Company, Inc., Tokyo (JP)

(72) Inventors: Takanori MIYABE, Kanagawa (JP); Takafumi ODA, Kanagawa (JP); Tomonori KATO, Kanagawa (JP)

(21) Appl. No.: 16/079,908

(22) PCT Filed: Feb. 8, 2017
(86) PCT No.: PCT/JP2017/004542

§ 371 Date: Aug. 24, 2018

(30) Foreign Application Priority Data
Feb. 29, 2016 (JP) 2016-037575

(51) Int. Cl. C08L 67/02; B65D 1/02; C08L 77/06; B65D 85/84

(52) U.S. Cl. CPC C08L 67/02; B65D 1/0207; C08L 25/14; B65D 85/84; C08L 77/06

(57) ABSTRACT

Provided is a container for chlorine-based liquid bleaching agent composition, which accommodates a chlorine-based liquid bleaching agent composition therein and has excellent transparency, in which even when storied over a long period of time, the generation of a crack is suppressed.

The container of the present invention is a container for chlorine-based liquid bleaching agent composition containing 90 to 99.5 parts by mass of a polyester resin (A) and 0.5 to 10 parts by mass of a polyamide (B) (a sum total of the polyester resin (A) and the polyamide resin (B) is 100 parts by mass), wherein the polyester resin (A) has a structural unit derived from a dicarboxylic acid and a structural unit derived from a diol, 80 mol % or more of the structural unit derived from a dicarboxylic acid being a structural unit derived from terephthalic acid, and 80 mol % or more of the structural unit derived from a diol being a structural unit derived from ethylene glycol; and the polyamide resin (B) has a structural unit derived from a diamine and a structural unit derived from a dicarboxylic acid, 80 mol % or more of the structural unit derived from a diamine being a structural unit derived from xylylenediamine, and 80 mol % or more of the structural unit derived from a dicarboxylic acid being a structural unit derived from adipic acid.

### TECHNICAL FIELD

The present invention relates to a container for chlorine-based liquid bleaching agent composition and a bleaching agent article.

### BACKGROUND ART

Polyester resins represented by, for example, polyethylene terephthalate (PET), which are obtained by using, as monomers, an aromatic dicarboxylic acid compound and an aliphatic diol compound, have such advantages that they are excellent in transparency, mechanical properties, melt stability, solvent resistance, flavor retention, gas barrier properties, recyclability, and so on. Thus, aromatic polyester resins are widely used as various packaging materials, such as films, sheets, and hollow containers.

However, from the viewpoint of securing safety, containers which are used for transportation, storage, and so on of various chemicals are required to be excellent in environmental stress crack resistance (hereinafter sometimes abbreviated as “ESCR”). In general, in resin molded articles, there are differences in pressure, mold shrinkage rate, molecular orientation at the time of flowing in a die, and so on, and thus, a residual stress, such as tension and compression, is present in a material. If some kind of external environmental substances (e.g., organic solvents, acids, bases, etc.) are present in a state where the residual stress retains, there is a case where a phenomenon in which a crack is generated and propagates to release the residual stress takes place, resulting in breakage. As an index indicating the durability until such a crack is generated, the ESCR is adopted. In addition, in containers filled with a chemical, in view of the matter that when the stress is applied, a time until a crack is generated is short, there is a case where the ESCR is adopted as an index for chemical resistance.

As mentioned above, the polyester resins are an excellent raw material; however, they have an ester bond within molecules thereof and are not satisfactory in alkali resistance. Thus, there was involved such a problem that when a container made of such a polyester resin accommodates an alkaline solution therein and is stored over a long period of time, the container is degraded to cause a crack (fracture).

PTL 1 describes, as a container having excellent alkali resistance, a container formed of a blend material of polyethylene naphthalate and polyethylene terephthalate.

In addition, hitherto, polyethylene containers and so on have been used as a container for accommodating an alkaline chlorine-based bleaching agent therein.

### CITATION LIST

### Patent Literature

PTL 1: JP H11-11532 A

### SUMMARY OF INVENTION

### Technical Problem

Polyethylene containers which have hitherto been used involve such a problem that since they are low in transparency and are formed upon being added with a coloring agent, the amount of an accommodated object cannot be visually confirmed from the outside. In addition, since the polyethylene containers is relatively high in oxygen permeability and not satisfactory in strength, it was necessary to thicken the container thickness.

In addition, in accommodating a chlorine-based liquid bleaching agent composition in a container made of PET, when stored over a long period of time, a crack is generated, so that sufficient ESCR could not be obtained.

Furthermore, in the invention described in PTL 1, in accommodating a chlorine-based liquid bleaching agent composition, the durability was not satisfactory.

An object of the present invention is to provide a container for chlorine-based liquid bleaching agent composition, which accommodates a chlorine-based liquid bleaching agent composition therein and has excellent transparency, in which even when stored over a long period of time, the generation of a crack is suppressed, and which is excellent in ESCR. Furthermore, another object of the present invention is to provide a bleaching agent article in which a chlorine-based liquid bleaching agent composition is accommodated in a container in which even when stored over a long period of time, the generation of a crack is suppressed, and which is excellent in ESCR.

### Solution to Problem

In view of the foregoing problems, the present inventors made extensive and intensive investigations. As a result, it has been found that by using a container for chlorine-based liquid bleaching agent composition, the container including a polyester resin (A), in which 80 mol % or more of a structural unit derived from a dicarboxylic acid is a structural unit derived from terephthalic acid, and 80 mol % or more of a structural unit derived from a diol is a structural unit derived from ethylene glycol; and a polyamide resin (B), in which 80 mol % or more of a structural unit derived from a diamine is a structural unit derived from xylylenediamine, and 80 mol % or more of the structural unit derived from a dicarboxylic acid is a structural unit derived from adipic acid, in specified contents, even in the case where the container is stored over a long period of time in a state of accommodating a chlorine-based liquid bleaching agent composition therein, the crack generation of the container is suppressed, leading to accomplishment of the present invention. The present invention provides the following [1] to [12].

[1] A container for chlorine-based liquid bleaching agent composition containing 90 to 99.5 parts by mass of a polyester resin (A) and 0.5 to 10 parts by mass of a polyamide resin (B) (a sum total of the polyester resin (A) and the polyamide resin (B) is 100 parts by mass), wherein the polyester resin (A) has a structural unit derived from a dicarboxylic acid and a structural unit derived from a diol, 80 mol % or more of the structural unit derived from a dicarboxylic acid being a structural unit derived from terephthalic acid, and 80 mol % or more of the structural unit derived from a diol being a structural unit derived from ethylene glycol; and the polyamide resin (B) has a structural unit derived from a diamine and a structural unit derived from a dicarboxylic acid, 80 mol % or more of the structural unit derived from a diamine being a structural unit derived from xylylenediamine, and 80 mol % or more of the structural unit derived from a dicarboxylic acid being a structural unit derived from adipic acid.

[2] The container for chlorine-based liquid bleaching agent composition as set forth in the above [1], wherein the chlorine-based liquid bleaching agent composition contains 0.5 to 15 mass % of sodium hypochlorite.

[3] The container for chlorine-based liquid bleaching agent composition as set forth in the above [1] or [2], wherein the chlorine-based liquid bleaching agent composition contains a surfactant.

[4] The container for chlorine-based liquid bleaching agent composition as set forth in any of the above [1] to [3], wherein the chlorine-based liquid bleaching agent composition contains an alkaline agent.

[5] The container for chlorine-based liquid bleaching agent composition as set forth in any of the above [1] to [4], wherein the container further contains an epoxy-functional polymer (C) including a styrene unit represented by the following formula (c1) and a glycidyl (meth)acrylate unit represented by the following formula (c2):

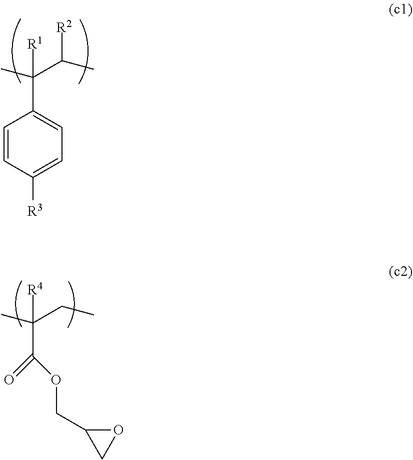

wherein R¹ to R⁴ each independently represent a hydrogen atom or an alkyl group having 1 to 12 carbon atoms.

[6] The container for chlorine-based liquid bleaching agent composition as set forth in any of the above [1] to [5], wherein the container is a single-layer container.

[7] A bleaching agent article including a container having a chlorine-based liquid bleaching agent composition accommodated therein, the container containing 90 to 99.5 parts by mass of a polyester resin (A) and 0.5 to 10 parts by mass of a polyamide resin (B) (a sum total of the polyester resin (A) and the polyamide resin (B) is 100 parts by mass), wherein the polyester resin (A) has a structural unit derived from a dicarboxylic acid and a structural unit derived from a diol, 80 mol % or more of the structural unit derived from a dicarboxylic acid being a structural unit derived from terephthalic acid, and 80 mol % or more of the structural unit derived from a diol being a structural unit derived from ethylene glycol; and the polyamide resin (B) has a structural unit derived from a diamine and a structural unit derived from a dicarboxylic acid, 80 mol % or more of the structural unit derived from a diamine being a structural unit derived from xylylenediamine, and 80 mol % or more of the structural unit derived from a dicarboxylic acid being a structural unit derived from adipic acid.

[8] The bleaching agent article as set forth in the above [7], wherein the chlorine-based liquid bleaching agent composition contains 0.5 to 15 mass % of sodium hypochlorite.

[9] The bleaching agent article as set forth in the above [7] or [8], wherein the chlorine-based liquid bleaching agent composition contains a surfactant.

[10] The bleaching agent article as set forth in any of the above [7] to [9], wherein the chlorine-based liquid bleaching agent composition contains an alkaline agent.

[11] The bleaching agent article as set forth in any of the above [7] to [10], wherein the container further contains an epoxy-functional polymer (C) including a styrene unit represented by the following formula (c1) and a glycidyl (meth)acrylate unit represented by the following formula (c2):

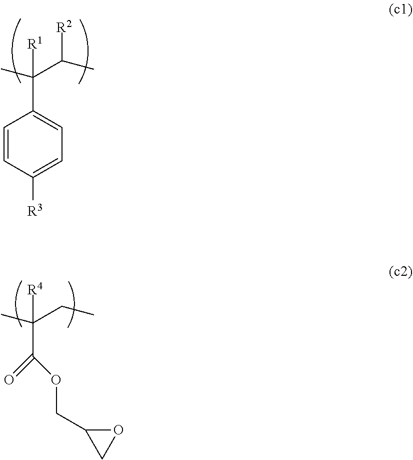

wherein R¹ to R⁴ each independently represent a hydrogen atom or an alkyl group having 1 to 12 carbon atoms.

[12] The bleaching agent article as set forth in any of the above [7] to [11] wherein the container is a single-layer container.

### Advantageous Effects of Invention

In accordance with the present invention, it is possible to provide a container for chlorine-based liquid bleaching agent composition, which accommodates a chlorine-based liquid bleaching agent composition therein and has excellent transparency, and in which even when stored over a long period of time, the generation of a crack is suppressed. Furthermore, in accordance with the present invention, it is possible to provide a bleaching agent article in which a chlorine-based liquid bleaching agent composition is accommodated in a container in which even when stored over a long period of time, the generation of a crack is suppressed.

### DESCRIPTION OF EMBODIMENTS

The present invention is hereunder described by reference to embodiments. In the following description, a description “A to B” representing a numerical value range represents “A or more and B or less” (in the case of A<B), or “A or less and B or more” (in the case of A>B). That is, the description “A to B” represents a numerical value range including A and B as end points.

In addition, the terms “parts by mass” and “mass %” are synonymous with “parts by weight” and “weight %”, respectively.

### [Container for Chlorine-Based Liquid Bleaching Agent Composition and Bleaching Agent Article]

The container for chlorine-based liquid bleaching agent composition of the present invention (hereinafter also referred to simply as “container”) contains 90 to 99.5 parts by mass of a polyester resin (A) and 0.5 to 10 parts by mass of a polyamide resin (B) (a sum total of the polyester resin (A) and the polyamide resin (B) is 100 parts by mass), wherein the polyester resin (A) has a structural unit derived from a dicarboxylic acid and a structural unit derived from a diol, 80 mol % or more of the structural unit derived from a dicarboxylic acid being a structural unit derived from terephthalic acid, and 80 mol % or more of the structural unit derived from a diol being a structural unit derived from ethylene glycol; and the polyamide resin (B) has a structural unit derived from a diamine and a structural unit derived from a dicarboxylic acid, 80 mol % or more of the structural unit derived from a diamine being a structural unit derived from xylylenediamine, and 80 mol % or more of the structural unit derived from a dicarboxylic acid being a structural unit derived from adipic acid.

In addition, the bleaching agent article of the present invention is one in which a chlorine-based liquid bleaching agent composition is accommodated in a container, the container being the aforementioned container for chlorine-based liquid bleaching agent composition of the present invention.

In the following description, a resin composition which comprises at least the polyester resin (A) and the polyamide resin (B), and is used for producing the container for chlorine-based liquid bleaching agent composition of the present invention is also referred to ‘a resin composition of the present invention’.

The present inventors have found that in the case where a polyester resin container, such as a PET bottle, which has hitherto been used, is used for a container for chlorine-based liquid bleaching agent composition, it is not satisfactory in chemical resistance, so that when stored over a long period of time, a crack is generated in the container. In particular, in the case where the chlorine-based liquid bleaching agent composition to be accommodated includes a surfactant, the generation of a crack was remarkable.

As a result of extensive and intensive investigations made by the present inventors, it has been found that by adding a specified amount of a specified polyamide resin to an aromatic polyester resin, such as PET, the generation of a crack when stored over a long period of time while accommodating a chlorine-based liquid bleaching agent composition therein is suppressed, leading to accomplishment of the present invention. Although the detailed action mechanism from which the effects are obtained is not elucidated yet, a part thereof may be presumed as follows.

Polyester resins represented by PET have an ester bond within molecules thereof, and hence, the ester bond is cut by the action of an alkali. As a result, it may be considered that the deterioration of the resin proceeds, so that a crack is generated due to long-term storage. In addition, in the case where the chlorine-based liquid bleaching agent composition which the container accommodates therein contains a surfactant, wettability of the container is improved, whereby the deterioration is more promoted. In particular, in the case where the chlorine-based liquid bleaching agent composition contains an alkaline surfactant, it may be considered that hydrolysis of the ester bond of the polyester resin is also promoted, whereby the deterioration is more promoted. On the other hand, by adding a specified polyamide resin, though the detailed mechanism thereof is not elucidated yet, it may be presumed that the alkali resistance of PET or the like is improved, whereby the generation of a crack is suppressed. In addition, it has been found that even in the case where the chlorine-based liquid bleaching agent composition which the container accommodates therein contains a surfactant, the aforementioned effects are thoroughly exhibited.

The container for chlorine-based liquid bleaching agent composition and the chlorine-based liquid bleaching agent composition which are used in the present invention are hereunder described. In the following description, the matter that the generation of a crack generated when accommodating the chlorine-based liquid bleaching agent composition therein is suppressed is also referred to as “resistance to chlorine-based liquid bleaching agent composition”.

### <Container for Chlorine-Based Liquid Bleaching Agent Composition>

### (Polyester Resin (A))

The polyester resin (A) has a structural unit derived from a dicarboxylic acid (hereinafter also referred to as “dicarboxylic acid unit”) and a structural unit derived from a diol (hereinafter also referred to as “diol unit”), in which 80 mol % or more of the dicarboxylic acid unit is a structural unit derived from terephthalic acid, and 80 mol % or more of the diol unit is a structural unit derived from ethylene glycol.

The content of a structural unit derived from terephthalic acid is preferably 85 mol % or more relative to the dicarboxylic acid unit, more preferably 90 mol % or more, and still more preferably 95 mol % or more.

The content of a structural unit derived from ethylene glycol is preferably 85 mol % or more relative to the diol unit, more preferably 90 mol % or more, and still more preferably 95 mol % or more.

In the following description, the polyester resin (A) is also referred to “polyethylene terephthalate”.

By controlling the proportion of the structural unit derived from terephthalic acid occupying in the dicarboxylic acid unit to 80 mol % or more as mentioned above, the polyester resin becomes hardly amorphous. Therefore, in the case where a container is produced by using the polyester resin, the heat shrinkage is hardly caused, and the heat resistance becomes favorable.

In the present invention, as the polyester resin, a polyester resin other than the polyester resin (A) may also be contained. The content of the polyester resin (A) relative to the total amount of the polyester resin is preferably 80 to 100 mass %, and more preferably 90 to 100 mass %.

The polyethylene terephthalate may also be one containing a structural unit derived from a bifunctional compound other than terephthalic acid and ethylene glycol.

In the present invention, a sulfophthalic acid or a sulfophthalic acid metal salt may also be used as the dicarboxylic acid. The sulfophthalic acid metal salt is a metal salt of a sulfophthalic acid, and examples of the metal atom include alkali metals, such as lithium, sodium, and potassium, alkaline earth metals, such as beryllium, magnesium, calcium, and strontium, and zinc. Among these, alkali metals are preferred, sodium or lithium is more preferred, and sodium is still more preferred.

In the sulfophthalic acid and sulfophthalic acid metal salt, though two carboxy groups may be bonded to any of an ortho position, a meta position, and a para position, the two carboxy groups are bonded preferably to a meta position or a para position, and more preferably to a meta position. That is, sulfoterephthalic acid, sulfoisophthalic acid, a sulfoterephthalic acid metal salt, or a sulfoisophthalic acid metal salt is preferred, and sulfoisophthalic acid or a sulfoisophthalic acid metal salt is more preferred.

The sulfophthalic acid and sulfophthalic acid metal salt may be substituted, and examples of the substituent include a substituted or unsubstituted alkyl group and a substituted or unsubstituted aryl group. The carbon atom number of the alkyl group is preferably 1 to 8, more preferably 1 to 6, and still more preferably 1 to 4. Specifically, examples thereof include a methyl group, an ethyl group, an n-propyl group, an isopropyl group, an n-butyl group, a t-butyl group, an n-octyl group, and a 2-ethylhexyl group. The aforementioned aryl group is preferably an aryl group having 6 to 12 carbon atoms, and examples thereof include a phenyl group and a naphthyl group, with a phenyl being preferred.

Specifically, examples of the sulfophthalic acid and sulfophthalic acid metal salt include 5-sulfoisophthalic acid, sodium 5-sulfoisophthalate, lithium 5-sulfoisophthalate, potassium 5-sulfoisophthalate, calcium bis(5-sulfoisophthalate), sodium dimethyl 5-sulfoisophthalate, and sodium diethyl 5-sulfoisophthalate.

In the case where the polyester resin (A) contains a structural unit derived from at least one selected from the group consisting of sulfophthalic acid and a sulfophthalic acid metal salt, it is preferred that at least a structural unit derived from a sulfophthalic acid metal salt is contained.

The total content of the structural unit derived from the sulfophthalic acid and sulfophthalic acid metal salt in the polyester resin (A) is preferably 0.01 to 15 mol %, more preferably 0.03 to 10.0 mol %, still more preferably 0.06 to 5.0 mol %, and yet still more preferably 0.08 to 1.0 mol % of the whole of the structural units derived from the dicarboxylic acid.

An aromatic dicarboxylic acid other than terephthalic acid may also be contained as the dicarboxylic acid. Examples of the aromatic dicarboxylic acid other than terephthalic acid include isophthalic acid, o-phthalic acid, biphenyldicarboxylic acid, diphenyl ether dicarboxylic acid, diphenylsulfone dicarboxylic acid, diphenylketone dicarboxylic acid, 2,6-naphthalenedicarboxylic acid, 1,4-naphthalenedicarboxylic acid, and 2,7-naphthalenedicarboxylic acid, and isophthalic acid, o-phthalic acid, naphthalenedicarboxylic acid, and 4,4′-biphenyldicarboxylic acid are preferred.

The polyester resin (A) may contain an aliphatic diol other than ethylene glycol as the diol constituting the polyester resin (A). Examples of the aliphatic diol other than ethylene glycol include aliphatic diols having a linear or branched structure, such as 2-butene-1,4-diol, trimethylene glycol, tetramethylene glycol, hexamethylene glycol, neopentyl glycol, methylpentanediol, and diethylene glycol; and alicyclic diols, such as cyclohexanedimethanol, isosorbide, spiro glycol, 2,2,4,4-tetramethyl-1,3-cyclobutanediol, norbornene dimethanol, and tricyclodecane dimethanol. Among these, neopentyl glycol and cyclohexanedimethanol are preferred.

Examples of the bifunctional compound other than the aliphatic diol and aromatic dicarboxylic acid include aliphatic bifunctional compounds other than the aliphatic diol and aromatic bifunctional compounds other than the aromatic dicarboxylic acid.

Examples of the aliphatic bifunctional compound other than the aliphatic diol include linear or branched aliphatic bifunctional compounds. Specifically, examples thereof include aliphatic dicarboxylic acids, such as malonic acid, succinic acid, adipic acid, azelaic acid, and sebacic acid; and aliphatic hydroxycarboxylic acids, such as 10-hydroxyoctadecanoic acid, lactic acid, hydroxyacrylic acid, 2-hydroxy-2-methylpropionic acid, and hydroxybutyric acid.

Although the aromatic bifunctional compound other than the aromatic dicarboxylic acid is not particularly limited, specific examples thereof include aromatic hydroxycarboxylic acids, such as hydroxybenzoic acid, hydroxytoluic acid, hydroxynaphthoic acid, 3-(hydroxyphenyl)propionic acid, hydroxyphenylacetic acid, and 3-hydroxy-3-phenylpropionic acid; and aromatic diols, such as a bisphenol compound and a hydroquinone compound, as well as their alkylene oxide adducts of, e.g., ethylene oxide, propylene oxide, etc.

In the case where the polyethylene terephthalate includes a structural unit derived from an aromatic dicarboxylic acid other than the sulfophthalic acid, sulfophthalic acid metal salt, and terephthalic acid, it is preferred that the aromatic dicarboxylic acid is selected from the group consisting of isophthalic acid, o-phthalic acid, naphthalenedicarboxylic acid, and 4,4′-biphenyldicarboxylic acid. These compounds are low in costs, and a copolymerized polyester resin containing one member of these compounds is easily produced. In the case where the polyethylene terephthalate includes a structural unit derived from such an aromatic dicarboxylic acid, the proportion of the structural unit derived from the aromatic dicarboxylic acid is preferably 1 to 20 mol %, and more preferably 1 to 10 mol % of the dicarboxylic acid unit.

Among these, the aromatic dicarboxylic acid is especially preferably isophthalic acid or naphthalenedicarboxylic acid, and most preferably isophthalic acid. The polyethylene terephthalate including a structural unit derived from isophthalic acid is excellent in moldability and is excellent from the standpoint of preventing blushing of a molded article due to the matter that a crystallization rate becomes slow. The polyethylene terephthalate including a structural unit derived from a naphthalenedicarboxylic acid increases a glass transition point of the resin, improves the heat resistance, and absorbs an ultraviolet ray, and therefore, it is suitably used for the production of a molded product which is required to be resistant to an ultraviolet ray. As the naphthalenedicarboxylic acid, a 2,6-naphthalenedicarboxylic acid component is preferred because it is easily produced and is high in economy.

The polyester resin (A) may also include a structural unit derived from a monofunctional compound, such as a monocarboxylic acid and a monoalcohol. Specific examples of such a compound include aromatic monofunctional carboxylic acid, such as benzoic acid, o-methoxybenzoic acid, m-methoxybenzoic acid, p-methoxybenzoic acid, o-methylbenzoic acid, m-methylbenzoic acid, p-methylbenzoic acid, 2,3-dimethylbenzoic acid, 2,4-dimethylbenzoic acid, 2,5-dimethylbenzoic acid, 2,6-dimethylbenzoic acid, 3,4-dimethylbenzoic acid, 3,5-dimethylbenzoic acid, 2,4,6-trimethylbenzoic acid, 2,4,6-trimethoxybenzoic acid, 3,4,5-trimethoxybenzoic acid, 1-naphthoic acid, 2-naphthoic acid, 2-biphenylcarboxylic acid, 1-naphthaleneacetic acid, and 2-naphthaleneacetic acid; aliphatic monocarboxylic acids, such as propionic acid, butyric acid, n-octanoic acid, n-nonanoic acid, myristic acid, pentadecanoic acid, stearic acid, oleic acid, linoleic acid, and linolenic acid; aromatic monoalcohols, such as benzyl alcohol, 2,5-dimethylbenzyl alcohol, 2-phenethyl alcohol, phenol, 1-naphthol, and 2-naphthol; and aliphatic monoalcohols, such as butyl alcohol, hexyl alcohol, octyl alcohol, pentadecyl alcohol, stearyl alcohol, a polyethylene glycol monoalkyl ether, a polypropylene glycol monoalkyl ether, a polytetramethylene glycol monoalkyl ether, and oleyl alcohol.

Among these, from the viewpoints of easiness of the production of polyester and production costs thereof, benzoic acid, 2,4,6-trimethoxybenzoic acid, 2-naphthoic acid, stearic acid, and stearyl alcohol are preferred. The proportion of the structural unit derived from the monofunctional compound is preferably 5 mol % or less, more preferably 3 mol % or less, and still more preferably 1 mol % or less relative to the total moles of all of the structural units of the polyester resin (A). The monofunctional compound functions as a terminal-sealing agent for end groups of the polyester resin molecular chain or end groups of the branched chain, thereby suppressing an excessive increase of the molecular weight of the polyester resin (A) and preventing gelation from occurring.

Furthermore, in order to obtain necessary physical properties, the polyester resin (A) may include, as a copolymerization component, a polyfunctional compound having at least three groups selected from a carboxy group, a hydroxy group, and an ester-forming group thereof. Examples of the polyfunctional compound include aromatic polycarboxylic acids, such as trimesic acid, trimellitic acid, 1,2,3-benzenetricarboxylic acid, pyromellitic acid, and 1,4,5,8-naphthalenetetracarboxylic acid; aromatic polyhydric alcohols, such as 1,3,5-trihydroxybenzene; aliphatic polyhydric alcohols, such as trimethylolpropane, pentaerythritol, and glycerin; aromatic hydroxycarboxylic acids, such as 4-hydroxyisop hthalic acid, 3-hydroxyisop hthalic acid, 2,3 -dihydroxybenzoic acid, 2,4-dihydroxybenzoic acid, 2,5-dihydroxybenzoic acid, 2,6 -dihydroxybenzoic acid, protocatechuic acid, gallic acid, and 2, 4-dihydroxyphenylacetic acid; aliphatic hydroxycarboxylic acids, such as tartaric acid and malic acid; and esters thereof.

The proportion of the structural unit derived from the polyfunctional compound in the polyester resin (A) is preferably less than 0.5 mol % relative to the total moles of all of the structural units of the polyester resin (A).

Among those mentioned above, from the viewpoints of reactivity and production costs, examples of the preferred polyfunctional compound include trimellitic acid, pyromellitic acid, trimesic acid, trimethylolpropane, and pentaerythritol.

For the production of the polyester resin (A), a known method, such as direct esterification and trans-esterification, may be applied. Examples of a polycondensation catalyst which is used in the production of the polyester resin (A) may include antimony compounds, such as antimony trioxide and antimony pentoxide; germanium compounds, such as germanium oxide; and aluminum compounds, such as aluminum chloride, but it should not be construed that the polycondensation catalyst is limited thereto. In addition, examples of other production method include a method of subjecting polyester resins of a different kind from each other to trans-esterification through long residence time and/or high-temperature extrusion.

The polyester resin (A) may possibly include a small amount of a diethylene glycol by-product unit which is a dimer of the ethylene glycol component and is formed in a small amount in a production step of polyester resin. In order that the molded product keeps favorable physical properties, it is preferred that the proportion of the diethylene glycol unit in the polyester resin is low as far as possible. The proportion of the structural unit derived from diethylene glycol is preferably 3 mol % or less, more preferably 2 mol % or less, and still more preferably 1 mol % or less relative to all of the structural units of the polyester resin (A).

The polyester resin (A) may include a regenerated polyester resin, or a material derived from an already used polyester or already industrially recycled polyester (for example, a polyester monomer, a catalyst, and an oligomer).

The polyester resin (A) may be used singly or in combination of two or more.

Although an intrinsic viscosity of the polyester resin (A) is not particularly limited, it is preferably 0.5 to 2.0 dL/g, and more preferably 0.6 to 1.5 dL/g. When the intrinsic viscosity is 0.5 dL/g or more, the polyester resin has a sufficiently high molecular weight, and hence, the container may reveal mechanical properties necessary as a structure.

The intrinsic viscosity is one measured by dissolving a polyester resin as a measurement object in a mixed solvent of phenol/1,1,2,2-tetrachloroethane (=G/4 mass ratio) to prepare 0.2, 0.4, and 0.6 g/dL solutions, followed by measurement at 25° C. with an automatic kinematic viscosity tester (Viscotek, manufactured by Malvern Instruments Limited).

### (Polyamide Resin (B))

The polyamide resin (B) has a structural unit derived from a diamine (hereinafter also referred to as “diamine unit”) and a structural unit derived from a dicarboxylic acid (hereinafter also referred to as “dicarboxylic acid unit”), in which 80 mol % or more of the diamine unit is a structural unit derived from xylylenediamine, and 80 mol % or more of the dicarboxylic acid unit is a structural unit derived from adipic acid.

The polyamide resin (B) contains, as the diamine unit, 80 mol % or more, preferably 85 mol % or more, more preferably 90 mol % or more, and still more preferably 95 mol % or more of the structural unit derived from xylylenediamine. When 80 mol % or more of the diamine unit is composed of the structural unit derived from xylylenediamine, the generation of a crack by the chlorine-based liquid bleaching agent composition in the container obtained using the polyamide may be efficiently suppressed, and the ESCR may be improved.

Although the xylylenediamine may be any of o-, m-, and p-xylylenediamines, from the viewpoints of resistance to chlorine-based liquid bleaching agent composition of the resulting container, ESCR, and easiness of availability, the xylylenediamine is preferably m-xylylenediamine.

The polyamide resin (B) contains, as the dicarboxylic acid unit, 80 mol % or more, preferably 85 mol % or more, more preferably 90 mol % or more, and still more preferably 95 mol % or more of the structural unit derived from adipic acid. When 80 mol % or more of the dicarboxylic acid unit is composed of the structural unit derived from adipic acid, the resistance to chlorine-based liquid bleaching agent composition of the resulting container may be efficiently enhanced.

Examples of a compound which may constitute the diamine unit of the polyamide resin (B) include, in addition to xylylenediamine, diamines having an alicyclic structure, such as 1,3 -bis(aminomethyl) cyclohexane, 1,4 -bis(aminomethyl) cyclohexane, 1-amino -3-aminomethylcyclohexane, bis(4-aminocyclohexyl)methane, bis(3-methyl-4-aminocyclohexyl)methane, 2,2 -bis(4-aminocyclohexyl)propane, bis(aminop ropyl)piperazine, and aminoethylpiperazine; and aliphatic diamines, such as tetramethylenediamine, hexamethylenediamine, nonamethylenediamine, 2-methyl-1,5-pentanediamine, undecamethylenediamine, dodecamethylenediamine, 2,2,4-trimethylhexamethylenediamine, 2,4,4-trimethylhexamethylenediamine, and 5-methylnonamethylenediamine, but it should not be construed that the compound is limited thereto.

A trivalent or more polyvalent amine, such as bis(hexamethylene)triamine, may also be used so far as the effects of the present invention are not impaired.

Furthermore, a monoamine, such as butylamine, hexylamine, and octylamine, may also be used so far as the effects of the present invention are not impaired.

Examples of a compound which may constitute the dicarboxylic acid unit of the polyamide resin (B) may include, in addition to adipic acid, aliphatic dicarboxylic acids, such as succinic acid, glutaric acid, pimelic acid, suberic acid, azelaic acid, sebacic acid, and dodecanedicarboxylic acid; dicarboxylic acids having an alicyclic structure, such as 1,3-cyclohexanedicarboxylic acid, 1,4 -cyclohexanedicarboxylic acid, decalindicarboxylic acid, norbornanedicarboxylic acid, tricyclodecanedicarboxylic acid, pentacyclododecanedicarboxylic acid, isophoronedicarboxylic acid, and 3,9-bis(2-carboxyethyl)-2,4,8,10-tetraoxaspiro[5.5]undecane; dicarboxylic acids having an aromatic ring, such as terephthalic acid, isophthalic acid, phthalic acid, o-phthalic acid, 2 -methylterephthalic acid, naphthalenedicarboxylic acid, biphenyldicarboxylic acid, and tetralindicarboxylic acid; and short-chain alkyl esters thereof, but it should not be construed that the compound is limited thereto. Specifically, examples of the short-chain alkyl ester include those having 1 to 3 carbon atoms, namely a methyl ester, an ethyl ester, a propyl ester, and an isopropyl ester, and above all, a methyl ester is preferred.

A trivalent or more polyvalent carboxylic acid, such as trimellitic acid, trimesic acid, pyromellitic acid, and tricarballylic acid, may also be used so far as the effects of the present invention are not impaired.

Furthermore, a monocarboxylic acid, such as benzoic acid, propionic acid, and butyric acid, may also be used so far as the effects of the present invention are not impaired.

As for the unit which constitutes the polyamide resin (B), so long as the effects of the present invention are not impaired, in addition to the aforementioned diamine unit and dicarboxylic acid unit, a structural unit derived from a lactam, such as c-caprolactam and laurolactam, a structural unit derived from an aliphatic aminocarboxylic acid, such as aminocaproic acid, aminoundecanoic acid, and aminododecanoic acid, or a structural unit derived from an aromatic aminocarboxylic acid, such as p-aminomethylbenzoic acid, may also be used as a copolymerization unit.

In the present invention, a polyamide resin other than the polyamide resin (B) may also be contained as the polyamide resin. The content of the polyamide resin (B) is preferably 80 to 100 mass %, and more preferably 90 to 100 mass % relative to the whole amount of the polyamide resin.

Specific examples of the polyamide resin other than the polyamide resin (B) include polycaproamide (nylon 6), polyhexamethyleneadipamide (nylon 66), polyhexamethylenesebacamide (nylon 610), polyundecamethyleneadipamide (nylon 116), polyhexamethylenedodecamide (nylon 612), polyundecanamide (nylon 11), polydodecanamide (nylon 12), isophthalic acid-copolymerized poly-m-xylyleneadipamide (polyamide MXD6I) (however, the content of the structural unit derived from isophthalic acid is more than 20 mol % of the dicarboxylic acid unit), and a copolymerized amide thereof (for example, nylon 66/6 (a copolymer of nylon 66 and nylon 6)). These polyamide resins may be used singly or in combination of two or more.

It is preferred that the polyamide resin (B) is produced through melt polycondensation (melt polymerization).

Examples of the melt polycondensation include a method in which a nylon salt formed of a diamine and a dicarboxylic acid is heated in the presence of water under pressurized conditions, and the nylon salt is polymerized in a molten state while added water and condensation water are removed.

The polyamide resin (B) may also be produced through a method in which a diamine is added directly to a dicarboxylic acid melt, and the mixture is subjected to polycondensation. In this case, in order to maintain the reaction system in a homogeneous liquid state, the diamine is continuously added to the dicarboxylic acid during polycondensation, while the reaction system is heated so that the reaction temperature does not lower the melting points of the formed oligoamides and polyamide.

To the polyamide resin (B) polycondensation system, a phosphorus atom-containing compound may be added for the purpose of promoting amidation or preventing coloring during polycondensation.

Examples of the phosphorus atom-containing compound include dimethylphosphinic acid, hypophosphorous acid, sodium hypophosphite, potassium hypophosphite, lithium hypophosphite, calcium hypophosphite, ethyl hypophosphite, phenylphosphonous acid, sodium phenylphosphonite, ethyl phenylphosphonite, phenylphosphonic acid, ethylphosphonic acid, sodium phenylphosphonate, diethyl phenylphosphonate, sodium ethylphosphonate, potassium ethylphosphonate, phosphorous acid, sodium hydrogenphosphite, sodium phosphite, potassium phosphite, calcium phosphite, triethyl phosphite, triphenyl phosphite, and pyrophosphorous acid, but it should not be construed that the phosphorus atom-containing compound is limited thereto.

Among these, from the viewpoints of a high effect for promoting amidation and an excellent effect for preventing coloring, metal hypophosphites, such as sodium hypophosphite, potassium hypophosphite, lithium hypophosphite, and calcium hypophosphite are preferred, with sodium hypophosphite being more preferred.

The amount of the phosphorus atom-containing compound to be added to the polyamide resin (B) polycondensation system is preferably 1 to 500 ppm, more preferably 5 to 450 ppm, and still more preferably 10 to 400 ppm expressed in terms of the phosphorus atom concentration in the polyamide resin (B). Through controlling the amount of the phosphorus atom-containing compound to meet the above conditions, coloring of the polyamide during polycondensation and gelation of the polyamide can be prevented. Thus, the appearance of a molded article thereof may be maintained in a favorable state.

In addition to the phosphorus atom-containing compound, an alkali metal compound and/or an alkaline earth metal compound is preferably added to the polyamide resin (B) polycondensation system. In order to prevent coloring of the polyamide during polycondensation, the phosphorus atom-containing compound must be used in a sufficient amount. However, the phosphorus atom-containing compound may promote gelation of the polyamide in some cases. Therefore, it is preferred to make an alkali metal compound or an alkaline earth metal compound coexistent so as to control a rate of amidation. Examples thereof include alkali metal/alkaline earth metal hydroxides, such as lithium hydroxide, sodium hydroxide, potassium hydroxide, magnesium hydroxide, calcium hydroxide, and barium hydroxide; and alkali metal/alkaline earth metal acetates, such as lithium acetate, sodium acetate, potassium acetate, magnesium acetate, calcium acetate, and barium acetate. In the present invention, the alkali metal compound or the alkaline earth metal compound may be used without being limited to these compounds.

In the case where the alkali metal compound and/or the alkaline earth metal compound is added to the polyamide resin (B) polycondensation system, the ratio by mole of the compound to the phosphorus atom-containing compound is preferably adjusted to 0.5 to 2.0, more preferably 0.6 to 1.8, and still more preferably 0.7 to 1.5. Through controlling the ratio to meet the above conditions, it becomes possible to suppress gel formation, while amidation is promoted by the phosphorus atom-containing compound.

The polyamide resin (B) obtained through melt polycondensation is once taken out and then pelletized, followed by drying for use. In addition, solid-phase polymerization may be carried out in order to elevate the polymerization degree.

No particular limitation is imposed on the heating apparatus for carrying out drying and solid-phase polymerization, and any known apparatus may be employed by a known method. Examples of the heating apparatus which may be suitably employed in the present invention include a continuous mode heating drier; a rotary drum heating apparatus called a tumble drier, a conical drier, a rotary drier, etc.; and a conical heating apparatus having agitation blades therein, called Nauta mixer.

Particularly, when solid-phase polymerization of the polyamide is carried out, among the aforementioned apparatuses, a rotary drum heating apparatus is preferably employed because the rotary drum heating apparatus realizes complete closure of the system, thereby easily advancing polycondensation in a state where oxygen that likely causes coloring is removed.

Among indices of a polymerization degree of the polyamide resin (B), relative viscosity is generally employed.

The polyamide resin (B) has a relative viscosity of preferably 1.5 to 4.2, more preferably 1.6 to 4.0, still more preferably 1.7 to 3.8, and yet still more preferably 1.9 to 3.0.

Through controlling the relative viscosity of the polyamide resin (B) to meet the above conditions, the molding processing is stable, whereby a container having favorable appearance may be obtained.

In the present invention, the relative viscosity of the polyamide resin (B) means a value measured by the following method. Specifically, 0.2 g of the polyamide resin is precisely weighed and dissolved with stirring in 20 mL of 96 mass % sulfuric acid at 20 to 30° C. After the polyamide resin is completely dissolved, 5 mL of the solution is rapidly taken into a Cannon-Fenske viscometer and allowed to stand in a thermostat at 25° C. for 10 minutes, followed by measuring a falling time (t) of the solution. Also, a falling time (to) of 96 mass % sulfuric acid is similarly measured. The relative viscosity of the polyamide resin is calculated using the measured t and to values according to the following formula.

Relative viscosity=t/t₀

In the container of the present invention, when a sum total of the polyester resin (A) and the polyamide resin (B) is defined as 100 parts by mass, the container contains 90 to 99.5 parts by mass of the polyester resin (A) and 0.5 to 10 parts by mass of the polyamide resin (B).

When the sum total of the polyester resin (A) and the polyamide resin (B) is defined as 100 parts by mass, the content of the polyester resin (A) is preferably 91 parts by mass or more, more preferably 92 parts by mass or more, and still more preferably 93 parts by mass or more, and preferably 99 parts by mass or less, more preferably 98 parts by mass or less, still more preferably 97 parts by mass or less, yet still more preferably 96 parts by mass or less, and especially preferably 95 parts by mass or less.

When the sum total of the polyester resin (A) and the polyamide resin (B) is defined as 100 parts by mass, the content of the polyamide resin (B) is preferably 1 part by mass or more, more preferably 2 parts by mass or more, still more preferably 3 parts by mass or more, yet still more preferably 4 parts by mass or more, and especially preferably 5 parts by mass or more, and preferably 9 parts by mass or less, more preferably 8 parts by mass or less, and still more preferably 7 parts by mass or less.

When the content of the polyamide resin (B) is less than 0.5 parts by mass, it is difficult to thoroughly suppress the generation of a crack. When the content of the polyamide resin (B) is more than 10 parts by mass, the transparency of the resulting container becomes inferior.

Although the container of the present invention may contain other components than the aforementioned polyester resin (A) and polyamide resin (B), the sum total of the polyester resin (A) and the polyamide resin (B) is preferably 50 mass % or more, more preferably 70 mass % or more, still more preferably 80 mass % or more, and yet still more preferably 90 mass % or more of the whole of the container.

### (Other Components)

Examples of other components which the container of the present invention may contain include a terminating reactant, a recycle aid agent, and a transition metal.

In the present invention, ‘the container of the present invention comprises Component X’ means that the container of the present invention is produced by using a resin composition comprising Component X, and includes the case where Component X has reacted with another component during producing process.

### [Terminating Reactant]

As described in JP 11-80522 A, it is known that the terminating reactant has such properties that it reacts with a carboxy group existent in an end of the carbon chain of polyester or polyamide, and it reacts with the carboxy terminal to seal it, thereby especially improving the hydrolysis resistance of polyester. As the terminating reactant, any optional material may be used so long as it is a compound capable of sealing a carboxy group (carboxy terminal) existent in an end of the carbon chain of polyester or polyamide.

As the terminating reactant which is used in the present invention, a compound capable of not only sealing the end of polyester but also sealing a carboxy group of a terminated carboxylic acid or acidic low-molecular compound produced through thermal decomposition or hydrolysis or the like is preferred. Furthermore, the terminating reactant is more preferably a compound capable of further sealing a hydroxy group terminal in an acidic low-molecular compound produced by thermal decomposition or hydrolysis or the like.

The terminating reactant may be either polyfunctional or monofunctional. A polyfunctional terminating reactant has such an advantage that when a main chain of polyester is cut, it is able to maintain physical properties, such as melt tension, and also has such an advantage that the polyfunctional terminating reactant works as a turning point, so that an improvement in melt tension is admitted, and moldability (neck-in, etc.) is improved. The monofunctional terminating reactant is less in molecular weight or steric hindrance than the polyfunctional type, and therefore, it has such an advantage that it rapidly reacts with the carboxy terminal of polyester, thereby achieving sealing.

As such a terminating reactant, for example, it is preferred to use at least one selected from the group consisting of a carbodiimide compound, an isocyanate compound, an epoxy compound, and an oxazoline compound.

The carbodiimide compound is a compound having one or more carbodiimide groups in a molecule thereof (inclusive of a polycarbodiimide compound). Such a carbodiimide compound may be, for example, synthesized by subjecting an isocyanate compound to decarboxylation condensation at a temperature of 70° C. or higher in the absence of a solvent or in an inert solvent by using an organic phosphorus-based compound or organic metal compound as a catalyst.

Although the carbodiimide compound may be used singly, a mixture of plural compounds may also be used.

In the present invention, it is preferred to use a polycarbodiimide compound as the terminating reactant, and as for its polymerization degree, a lower limit thereof is preferably 2 or more, and more preferably 4 or more, and an upper limit thereof is preferably 40 or less, and more preferably 30 or less. When the polymerization degree is too low, the carbodiimide compound is vaporized at the time of molding, so that the effect tends to become low. On the other hand, when the polymerization degree is too high, dispersibility in the composition becomes insufficient, so that there is a case where the terminal sealing effect is not efficiently obtained.

Examples of the industrially available polycarbodiimide may include Carbodilite (registered trademark) HMV-8CA (manufactured by Nisshinbo Chemical Inc.), Carbodilite (registered trademark) LA-1 (manufactured by Nisshinbo Chemical Inc.), Stabaxol P (manufactured by Rhein Chemie Corporation), and Stabaxol P100 (manufactured by Rhein Chemie Corporation).

Examples of the isocyanate compound include cyclohexyl isocyanate, n-butyl isocyanate, phenyl isocyanate, 2,6-diisopropylphenyl isocyanate, 4,4′-dicyclohexylmethane diisocyanate, isophorone diisocyanate, tetramethylxylylene diisocyanate, 2,4,6-triisopropylphenyl diisocyanate, 4,4′-diphenylmethane diisocyanate, tolidine diisocyanate, and hexamethylene diisocyanate.

Examples of the epoxy compound include butylphenyl glycidyl ether, resorcinol diglycidyl ether, hydroquinone diglycidyl ether, 1,6-hexanediol diglycidyl ether, hydrogenated bisphenol A diglycidyl ether, N-glycidyl phthalimide, diglycidyl terephthalate, a bisphenol A type epoxy resin and/or novolak type epoxy resin, and an ethylene-glycidyl methacrylate-vinyl acetate copolymer.

Examples of the oxazoline compound include bisoxazolines, such as 2,2′-bis(2-oxazoline), 1,3-phenylene-bis(2-oxazoline), 2, 2′-m-phenylene bis(2-oxazoline), and 2,2′-p-phenylene bis(2-oxazoline). Also, examples thereof include oxazoline group-containing polymers, such as an oxazoline group-containing polystyrene, an oxazoline group-containing acrylic polymer, and an oxazoline group-containing styrene-acrylic polymer. Examples of the industrially available oxazoline group-containing polymer include Epocros (registered trademark) K series, WS series, and RPS (manufactured by Nippon Shokubai Co., Ltd.).

Besides, examples of the terminating reactant include epoxy compounds, such as a glycidyl ester compound, a glycidyl amine compound, a glycidyl imide compound, and an alicyclic epoxy compound; and oxazine compounds.

The aforementioned terminating reactant may be used singly, or two or more thereof may be arbitrarily combined and used in an arbitrary ratio.

It is preferred that the container of the present invention contains, as the terminating reactant, an epoxy-functional polymer (C) including a styrene unit represented by the following formula (c1) and a glycidyl (meth)acrylate unit represented by the following formula (c2):

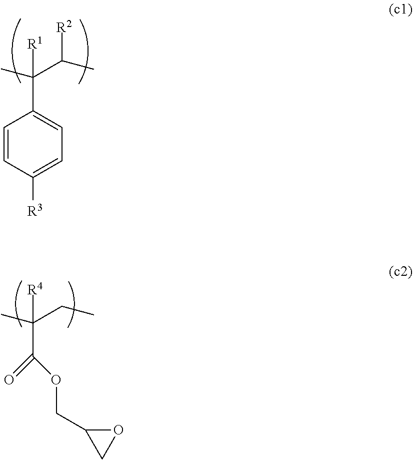

wherein R¹ to R⁴ each independently represent a hydrogen atom or an alkyl group having 1 to 12 carbon atoms.

The aforementioned epoxy-functional polymer (C) is preferably a polymer including a styrene unit represented by the following formula (c1), a glycidyl (meth)acrylate unit represented by the following formula (c2), and a (meth)acrylate unit represented by the following formula (c3):

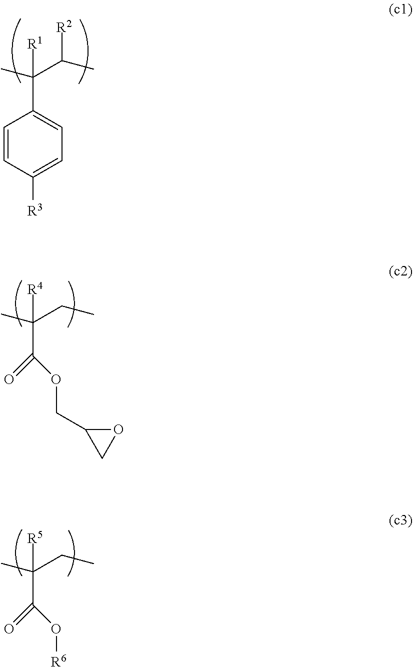

wherein R¹ to R⁵ each independently represent a hydrogen atom or an alkyl group having 1 to 12 carbon atoms; and R⁶ represents an alkyl group having 1 to 12 carbon atoms.

In the formulae (c1) to (c3), though R¹ to R⁵ each independently represent a hydrogen atom or an alkyl group having 1 to 12 carbon atoms, in the case where R¹ to R⁵ are each an alkyl group, the carbon number of the alkyl group is 1 to 12, and preferably 1 to 6, and the alkyl group may be linear, branched, or cyclic. Specific examples of the alkyl group include a methyl group, an ethyl group, and a propyl group, with a methyl group being especially preferred.

In the formula (c1), R¹ to R³ are each preferably a hydrogen atom or a methyl group, and especially preferably a hydrogen atom.

In the formula (c2), R⁴ is preferably a hydrogen atom or a methyl group, and especially preferably a methyl group.

In the formula (c3), R⁵ is preferably a hydrogen atom or a methyl group, and especially preferably a methyl group. In addition, R⁶ represents an alkyl group having 1 to 12 carbon atoms, the carbon number of the alkyl group is preferably 1 to 6, and the alkyl group may be linear, branched, or cyclic. Specific examples of the alkyl group include a methyl group, an ethyl group, and a propyl group, with a methyl group being especially preferred.

Of these, the case where in the formula (c1), R¹ to R³ are each a hydrogen atom, the case where in the formula (c2), R⁴ is a methyl group, and the case where in the formula (c3), R⁵ is a methyl group are especially preferred in view of the fact that a molded product composed of the epoxy-functional polymer-containing resin composition is excellent in transparency.

The number x of the styrene unit represented by the formula (c1) and the number y of the glycidyl (meth)acrylate unit represented by the formula (c2), each of which is included in the epoxy-functional polymer (C), are each independently 1 to 35; y is preferably 2 to 30, and more preferably 4 to 25 from the viewpoint of transparency; and (x+y) is preferably 10 to 70, and more preferably 15 to 60.

In the case where the epoxy-functional polymer (C) has a (meth)acrylate unit represented by the formula (c3), the number x of the styrene unit represented by the formula (c1), the number y of the glycidyl (meth)acrylate unit represented by the formula (c2), and the number z of the (meth)acrylate unit represented by the formula (c3) are each independently 1 to 20; y is preferably 2 to 20, and more preferably 3 to 10 from the viewpoint of transparency; and (x+z) is preferably more than 10.

These structural units may be linked in any sequence. Thus, the epoxy-functional polymer (C) may be either a block copolymer or a random copolymer.

As the epoxy-functional polymer (C), a commercial available product, for example, “Joncryl ADR” (trade name), manufactured by BASF SE, may be used. Specifically, examples thereof include Joncryl ADR-4368, Joncryl ADR-4300, Joncryl ADR-4385, and Joncryl ADR-4380.

In the present invention, when the epoxy-functional polymer (C) is blended in the resin component containing the polyester resin (A) and the polyamide resin (B), the transparency may be improved without worsening the resistance to chlorine-based liquid bleaching agent composition, and therefore, such is preferred. Although the action mechanism is not elucidated yet, one conceivable mechanism is that polymer end groups of the polyester resin (A) and the polyamide resin (B) chemically react with the epoxy-functional polymer (C), whereby islands of the polyamide resin (B) are possibly micro-dispersed in the sea matrix of the polyester resin (A).

When the whole amount of the polyester resin and polyamide resin including the polyester resin (A) and the polyamide resin (B) is defined as 100 parts by mass, the content of the terminating reactant including the epoxy-functional polymer (C) is preferably 0.005 to 0.1 parts by mass, and more preferably 0.02 to 0.05 parts by mass. When the content is 0.005 parts by mass or more, the transparency is improved, and hence, such is preferred. When the content is 0.1 parts by mass or less, the melt viscosity of the resulting resin composition is low, and the moldability is excellent, and hence, such is preferred.

### [Recycle Aid Agent]

The container of the present invention may contain a recycle aid agent. In obtaining a regenerated polyester resin, the recycle aid agent is a compound having an effect for suppressing yellowing in a regeneration step, and as the recycle aid agent, an aldehyde scavenger is preferably exemplified.

As the recycle aid agent, a compound having ability of suppressing yellowing of the polyester resin and having an amino group is exemplified. Specifically, the recycle aid agent is preferably at least one compound selected from the group consisting of aminobenzamide, aminobenzoic acid, diaminobenzoic acid, and nylon 6I/6T, and more preferably at least one compound selected from the group consisting of anthranylamide, anthranilic acid, and nylon 6I/6T.

As for the aminobenzamide, though the amino group may be substituted at any of the 2- to 4-positions, it is preferably substituted at the 2- or 3-position. The aminobenzamide is preferably anthranylamide (2-aminobenzamide) represented by the following formula.

As for the aminobenzoic acid, though the amino group may be substituted at any of the 2- to 4-positions, it is preferably substituted at the 2- or 3-position. The aminobenzoic acid is preferably anthranilic acid (2-aminobenzoic acid) represented by the following formula.

As for the diaminobenzoic acid, though the amino groups may be substituted at any of the 2,3-, 2,4-, and 3,4-positions, 3,4-diaminobenzoic acid is preferred.

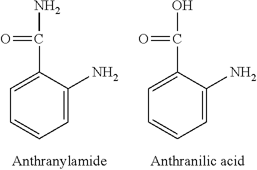 [SMILES: NC(=O)c1ccccc1N ; Nc1ccccc1C(=O)O]

The nylon 6I/6T is a hexamethylenediamine-isophthalic acid-terephthalic acid copolymer polyamide and is a hexamethylene isophthalamide/hexamethylene terephthalamide copolymer. A commercially available product may be used as the nylon 6I/6T, and examples thereof include Selar (registered trademark) PA 3426 (manufactured by Du Pont) and NOVAMID X21 (manufactured by DSM).

A weight average molecular weight of nylon 6I/6T is preferably 10,000 to 50,000, more preferably 15,000 to 45,000, and still more preferably 20,000 to 40,000. The weight average molecular weight is a value measured by means of gel permeation chromatography and converted by using polystyrene as standard. When the weight average molecular weight of nylon 6I/6T falls within the foregoing range, not only excellent compatibility with the polyester resin is revealed, but also when formed into a container, elution of the contents is suppressed, and yellowing is effectively suppressed.

An amino end group concentration of nylon 6I/6T is preferably 50 to 350 μmol/g, more preferably 100 to 300 μmol/g, and still more preferably 150 to 250 μmol/g. When the amino end group concentration of nylon 6I/6T falls within the foregoing range, an excellent action of suppressing yellowing of the regenerated polyester is revealed.

The amino end group concentration is determined in a manner in which nylon 6I/6T is precisely weighed and dissolved in a phenol/ethanol (4/1 by volume) solution at 20 to 30° C. while stirring, after the nylon 6I/6T is completely dissolved, the inner wall of the container is washed away with 5 mL of methanol while stirring, and the resultant is subjected to neutral titration with a 0.01 mol/L hydrochloric acid aqueous solution.

Examples of the recycle aid agent include salicylamide, salicylanilide, o-phenylenediamine, 1,8-diaminonaphthalene, o-mercaptobenzamide, N-acetylglycinamide, malonamide, 3-mercapto-1,2-propanediol, histidine, tryptophan, 4-amino-3 -hydroxybenzoic acid, disodium 4,5-dihydroxy-2,7-naphthalenedisulfonate, biuret, 2,3 -diaminopyridine, 1,2 -diaminoanthraquinone, dianilinoethane, allantoin, 2-amino-2-methyl-1,3-propanediol, pentaerythritol, dipentaerythritol, and poly(vinyl alcohol).

The recycle aid agent may be used singly or in combination of two or more. In the present invention, the recycle aid agent is preferably at least one compound selected from the group consisting of anthranylamide and nylon 6I/6T, more preferably anthranylamide or nylon 6I/6T, and still more preferably anthranylamide.

When the whole amount of the polyester resin and polyamide resin including the polyester resin (A) and the polyamide resin (B) is defined as 100 parts by mass, from the viewpoint of effectively suppressing yellowing, the content of the recycle aid agent is preferably 0.005 to 3.0 parts by mass, more preferably 0.01 to 1.0 part by mass, and still more preferably 0.05 to 0.5 parts by mass.

### [Transition Metal]

For the purpose of inducing an oxidation reaction of the polyamide resin (B) to enhance an oxygen absorption function and to enhance gas barrier properties, the container of the present invention may include a transition metal.

The transition metal is preferably at least one selected from the group consisting of transition metals, such as iron, cobalt, nickel, manganese, copper, and zinc, and from the viewpoint of revealing oxygen absorption ability, the transition metal is more preferably at least one selected from cobalt, iron, manganese, and nickel, and still more preferably cobalt.

The transition metal is used as not only a simple substance but also in a form of a low-valence oxide, an inorganic acid salt, an organic acid salt, or a complex salt each containing the aforementioned metal. Examples of the inorganic acid salt include halides, such as a chloride and a bromide, carbonates, sulfates, nitrates, phosphates, and silicates. Meanwhile, examples of the organic acid salt include carboxylates, sulfonates, and phosphonates. Transition metal complexes with a β-diketone or a β-keto acid ester or the like may also be utilized.

In the present invention, from the viewpoint of favorably revealing oxygen absorption ability, it is preferred to use at least one selected from the group consisting of a carboxylate, a carbonate, an acetylacetonate complex, an oxide, and a halide each containing a transition metal; it is more preferred to use at least one selected from the group consisting of an octanoate, a neodecanoate, a naphthenate, a stearate, an acetate, a carbonate, and an acetylacetonate complex; and it is still more preferred to use a cobalt carboxylate, such as cobalt octanoate, cobalt naphthenate, cobalt acetate, and cobalt stearate.

The transition metal may be used singly or in combination of two or more. In the present invention, from the viewpoint of enhancing gas barrier properties, the content of the transition metal in the container and the resin composition for forming a container is preferably 10 to 1,000 ppm, more preferably 20 to 500 ppm, still more preferably 50 to 300 ppm, and yet still more preferably 80 to 200 ppm. In the case of using a transition metal-containing carboxylate or the like, the content of the transition metal means the content of the transition metal per se in the transition metal-containing compound.

### [Other Components]

The container of the present invention may contain, in addition to the aforementioned components, various additive components. Examples of the additive component include a coloring agent, a heat stabilizer, a light stabilizer, a moistureproof agent, a waterproof agent, a lubricant, and a spreader.

### <Production Method of Container>

As for the container of the present invention, it is preferred to obtain a container by preparing a resin composition including at least the polyester resin (A) and the polyamide resin (B) and molding the resin composition.

### (Preparation Method of Resin Composition)

Although a production method of the resin composition is not particularly limited, for example, the desired resin composition may be obtained by melt-kneading the polyester resin (A) and the polyamide resin (B) in an extruder. On this occasion, the respective components of the resin composition may be simultaneously mixed and melt-kneaded. Alternatively, in order to enhance kneading dispersibility of a component of a less content, the resin composition of the present invention may be produced by preparing a master batch in advance and then again melt-kneading the master batch.

Specifically, after melt-kneading the polyester resin (A), the polyamide resin (B), and if desired, other components, such as a terminating reactant, a recycle aid agent, and a transition metal in advance to prepare a master batch, the master batch may be melt-kneaded with the polyester resin (A). Alternatively, after melt-kneading the polyester resin (A) and other components to prepare a master batch, the master batch, the polyester resin (A), and the polyamide resin (B) may be melt-kneaded, and the method is not particularly limited.

After mixing the master batch and the polyester resin (A) in a dry-blending mode in advance, the mixture may be melt-kneaded. After dry-blending the master batch and the polyester resin (A), the resulting dry-blended material may be charged as it is into a molding machine, such as an injection molding machine.

Furthermore, after weighing the master batch and the polyester (A) by a feeder, they may be molded as they are by a molding machine, such as an injection molding machine.

After dry-blending the master batch and the polyester resin (A) and then melt-kneading to obtain pellets of the polyester-based resin composition, the pellets may be molded.

A melt-kneading temperature is preferably 240 to 295° C., more preferably 245 to 292° C., and still more preferably 250 to 290° C.

Although a time of melt-kneading is not particularly limited, it is preferably 1 second to 5 minutes, more preferably 3 seconds to 4 minutes, and still more preferably 5 seconds to 3 minutes.

Although the apparatus which is used for melt-kneading is not particularly limited, examples thereof include an open-type mixing roll, a non-open-type Banbury mixer, a kneader, a continuous kneading machine (e.g., a single-screw kneading machine, a twin-screw kneading machine, a multi-screw kneading machine, etc.).

### (Production Method of Container and Container)

Although a production method of the container of the present invention is not particularly limited, it is preferred to include a step of molding the above-obtained resin composition.

The production method of the container of the present invention is not particularly limited, and any arbitrary method may be utilized.

For example, a container may be produced by injecting the melt of the resin composition from an injection molding machine into a die, thereby producing a preform, which is then heated to a stretching temperature to achieve blow-stretching. The container may also be obtained by compression molding, compression blow-molding, or compression stretching blow-molding.

The container of the present invention is preferably a bottle-shaped hollow container. The container is preferably a container obtained by stretching at least a part of a molded product at a stretch ratio of preferably 2 to 30 times, more preferably 3 to 25 times, and more preferably 5 to 20 times.

The container of the present invention is preferably a single-layer molded product. According to the container of the present invention, excellent resistance to chlorine-based liquid bleaching agent composition is obtained through a single-layer structure.

It is preferred that the container of the present invention has favorable gas barrier properties. In particular, when an oxygen permeation coefficient is low, the quality-maintaining ability of the chlorine-based liquid bleaching agent composition is improved, and hence, such is preferred.

In the case where no transition metal is contained, the oxygen permeation coefficient of the container of the present invention is preferably 1.60 ml·mm/(m²·day·atm) or less, more preferably 1.50 ml·mm/(m²·day·atm) or less, still more preferably 1.40 ml·mm/(m²·day·atm) or less, and yet still more preferably 1.35 ml·mm/(m²·day·atm) or less.

In the case where a transition metal is contained, the oxygen permeation coefficient of the container is preferably 0.10 ml·mm/(m²·day·atm) or less, more preferably 0.07 ml·mm/(m²·day·atm) or less, still more preferably 0.06 ml·mm/(m²·day·atm) or less, and yet still more preferably 0.04 ml·mm/(m²·day·atm) or less.

### [Chlorine-Based Liquid Bleaching Agent Composition]

The chlorine-based liquid bleaching agent composition which the container of the present invention accommodates therein is described in detail.

### <Bleaching Component>

The chlorine-based liquid bleaching agent composition preferably contains a chlorite, a hypochlorite, a chlorinated isocyanurate, or the like, more preferably contains a chlorite or a hypochlorite, and still more preferably contains a hypochlorite as a bleaching component.

The aforementioned chlorite, hypochlorite, or chlorinated isocyanurate is preferably a metal salt, and more preferably an alkali metal salt. The alkali metal is preferably sodium or potassium, and more preferably sodium.

It is especially preferred that the chlorine-based liquid bleaching agent composition contains sodium hypochlorite as the bleaching component.

In the case where the chlorine-based liquid bleaching agent composition contains sodium hypochlorite, the content of the sodium hypochlorite is preferably 0.5 to 15 mass %, more preferably 1 to 12 mass %, still more preferably 2 to 9 mass %, and yet still more preferably 2 to 8 mass %.

When the content of sodium hypochlorite falls within the foregoing range, favorable bleaching properties and storage stability are obtained, and hence, such is preferred.

While there is a case where the concentration of sodium hypochlorite varies with a lapse of time, it is preferred that the concentration of sodium hypochlorite at the time of production falls within the foregoing range.

### <Alkaline Agent>

In the present invention, the chlorine-based liquid bleaching agent composition may contain an alkaline agent. The alkaline agent is added for the purpose of not only enhancing stability of the bleaching component, such as sodium hypochlorite, in the chlorine-based liquid bleaching agent composition but also obtaining a sufficient effect against staining.

As the alkaline agent, an alkali metal hydroxide, or an alkali metal carbonate, silicate, or phosphate, or the like is used. As the alkali metal, sodium or potassium is preferably exemplified.

Examples of the alkali metal hydroxide include sodium hydroxide and potassium hydroxide. Examples of the alkali metal carbonate include sodium carbonate and potassium carbonate. Examples of the alkali metal phosphate include sodium tripolyphosphate, trisodium phosphate, tripotassium phosphate, sodium pyrophosphate, potassium pyrophosphate, and potassium polyphosphate; and examples of the alkali metal silicate include sodium orthosilicate, potassium orthosilicate, sodium metasilicate, and potassium metasilicate.

Among these, as the alkaline agent, an alkali metal hydroxide is preferred, and sodium hydroxide is more preferred.

The concentration of the alkaline agent in the chlorine-based liquid bleaching agent composition is preferably 0.1 mass % or more, and more preferably 0.2 mass % or more. The concentration of the alkaline agent is preferably 5 mass % or less, more preferably 3 mass % or less, still more preferably 1 mass % or less, and especially preferably 0.8 mass % or less. When the concentration of the alkaline agent falls within the foregoing range, the alkalinity is sufficient, the stability of sodium hypochlorite becomes favorable, and a sufficient effect against staining is obtained, and hence, such is preferred.

### Chelating Agent>

In the present invention, the chlorine-based liquid bleaching agent composition may also contain a chelating agent.

The chelating agent has a function to stabilize the chlorine-based liquid bleaching agent composition through trapping a heavy metal included in the chlorine-based liquid bleaching agent composition. Examples thereof include an aminophosphonic acid N-oxide, particularly [nitrilotris(methylene)]trisphosphonic acid N-oxide, a 2-phosphonobutane-1,2,4-tricarboxylic acid salt, a 1-hydroxyethane-1,1-diphosphonic acid salt, and a cross-linking type polycarboxylic acid salt.

Aminocarboxylic acid-based compounds, such as diethylenetriaminepentaacetic acid (DTPA), ethylenediaminetetraacetic acid (EDTA), nitrilotriacetic acid (NTA), hydroxyethyl ethylenediaminetriacetic acid (HEDTA), triethylenetetrahexaacetic acid (TTHA), dicarboxymethyl glutamic acid (GLDA), hydroxyethyl iminoacetic acid (HIDA), dihydroxyethyl glycine (DHEG), 1,3-propanediaminetetraacetic acid (PDTA), and 1,3-diamino-2-hydroxyp rop anetetraacetic acid (DPTA-OH); hydroxycarboxylic acid-based compounds, such as gluconic acid, malic acid, succinic acid, citric acid, lactic acid, tartaric acid, and salts thereof; and phosphoric acid-based compounds, such as hydroxyethylidene diphosphonic acid (HEDP), nitrilotrimethylene phosphonic acid (NTMP), phosphonobutanetricarboxylic acid (PBTC), and a hexametaphosphoric acid salt are not suitable because they tend to be decomposed themselves in the hypochlorite aqueous solution.

The chelating agent may be used singly or in combination of two or more, and there is no particular limitation.

The content of the chelating agent is preferably 0.1 to 30 mass %, and more preferably 0.3 to 20 mass % in the chlorine-based liquid bleaching agent composition. When the content of the chelating agent falls within the foregoing range, sufficient detergency is obtained.

### <Surfactant>

In the present invention, it is preferred that the chlorine-based liquid bleaching agent composition contains a surfactant. When the chlorine-based liquid bleaching agent composition contains a surfactant, the performance as a bleaching agent relative to articles having various surface physical properties is improved, and hence, such is preferred. Even in the case where the container of the present invention accommodates the surfactant-containing chlorine-based liquid bleaching agent composition therein and is stored over a long period of time, the container suppresses the generation of a crack and is excellent in ESCR. As the surfactant which the chlorine-based liquid bleaching agent composition contains, various surfactants, such as anionic, cationic, nonionic, or ampholytic surfactants, may be used.

Examples of the anionic surfactant include carboxylic acid salts, such as an alkyl carboxylate (carboxylic acid salt) and a polyalkoxy carboxylate, an alcohol ethoxylate carboxylate, and nonylphenyl ethoxylate carboxylate; sulfonic acid salts, such as an alkyl sulfonate, an alkyl benzenesulfonate, an alkylaryl sulfonate, and a sulfonated fatty acid ester; sulfuric acid salts, such as a sulfated alcohol, a sulfated alcohol ethoxylate, a sulfated alkylphenol, an alkyl sulfate, a sulfosuccinic acid ester, an alkyl ether sulfate, and a polyoxyalkylene alkyl ether sulfuric acid ester salt (also referred to as “alkyl ether sulfuric acid ester salt”); and phosphoric acid salt esters, such as an alkyl phosphoric acid salt ester. As the anionic surfactant, an alkylaryl sulfonate of sodium, an a-olefin sulfonate, a polyoxyalkylene alkyl ether sulfuric acid ester salt, and an aliphatic alcohol sulfate are preferred; a polyoxyalkylene alkyl ether sulfuric acid ester salt is more preferred; and a polyoxyethylene alkyl ether sulfuric acid ester salt is still more preferred.

The polyoxyethylene alkyl ether sulfuric acid ester salt is preferably a compound represented by the following formula (1):

CₙH₂ₙ₊₁O (C₂H₄O)ₘSO₃X (1)

wherein n is 10 to 30; m is 1 to 20; and X represents an alkali metal or a quaternary ammonium salt.

In the formula (1), n is preferably 12 to 18, and more preferably 12 to 16. m is preferably 1 to 16, more preferably 1 to 12, and still more preferably 1 to 8.

n and m each represent an average of the compound represented by the formula (1) and is a value obtained through molecular averaging of the carbon number or the addition number of an ethyleneoxy group.

Examples of the polyoxyethylene alkyl ether sulfuric acid ester salt include sodium polyoxyethylene lauryl ether sulfate.

The cationic surfactant which is used for the chlorine-based liquid bleaching agent composition includes amines, such as a primary, secondary, or tertiary amine having an alkyl chain or an alkenyl chain, an ethoxylated alkylamine, an alkoxylate of ethylenediamine, and an imidazole (e.g., 1-(2-hydroxyethyl)-2-imidazole, a 2-alkyl-1-(2-hydroxyethyl) -2-imidazoline, etc.); and quaternary ammonium salts, for example, alkyl quaternary ammonium chloride surfactants (e.g., an n-alkyl (C12-C18) dimethylbenzylammonium chloride, n-tetradecyldimethylbenzylammonium chloride monohydrate, and a naphthalene-substituted quaternary ammonium chloride (e.g., dimethyl 1-naphthylmethylammonium chloride, etc.). The cationic surfactant may be used for the purpose of giving sanitization properties.

The nonionic surfactant which is used for the chlorine-based liquid bleaching agent composition includes, for example, one having a polyalkylene oxide polymer as a part of the surfactant molecule. Such a nonionic surfactant includes, for example, chlorine-, benzyl-, methyl-, ethyl-, propyl-, butyl-, or similar alkyl-capped polyethylene glycol ethers of aliphatic alcohols; polyoxyalkylene oxide-non-containing nonionic substances, such as an alkyl polyglycoside; sorbitan and a sucrose ester or an ethoxylate; alkoxylated ethylenediamines; alcohol alkoxylates, such as an alcohol ethoxylate propoxylate, an alcohol propoxylate, an alcohol propoxylate ethoxylate propoxylate, and an alcohol ethoxylate butoxylate; carboxylic acid esters, such as glycerol esters, polyoxyethylene esters, or ethoxylate and glycol esters of fatty acids; carboxylic acid amides, such as a diethanolamine condensate, a monoalkanolamine condensate, and a polyoxyethylene fatty acid amide; polyalkylene oxide block copolymers inclusive of an ethylene oxide/propylene oxide block copolymer (commercially available under a trademark “PLURONIC” (registered trademark) (manufactured by BASF)); and similar nonionic compounds. A silicone surfactant, such as ABIL (registered trademark) B8852 (manufactured by Evonik), may also be used.

The ampholytic surfactant which is used for the chlorine-based liquid bleaching agent composition includes an alkylamine oxide, a betaine (e.g., carboxybetaine, sulfobetaine, etc.), an imidazoline, and a propionic acid salt.

Among these, as the surfactant, an anionic surfactant or an ampholytic surfactant is preferred, and a polyoxyalkylene alkyl ether sulfuric acid ester salt or an alkylamine oxide is more preferred.

The surfactant may be used singly or in combination of two or more. The content of the surfactant in the chlorine-based liquid bleaching agent composition is preferably 0.01 to 7.0 mass %, more preferably 0.03 to 5.0 mass %, and still more preferably 0.05 to 3.0 mass %.

In the present invention, the pH of the chlorine-based liquid bleaching agent composition is preferably alkaline. The pH at 20° C. is preferably 11 to 13.8, more preferably 11.3 to 13.7, and still more preferably 11.5 to 13.5. The pH of the chlorine-based liquid bleaching agent composition preferably falls within the foregoing range from the standpoints of storage stability and bleaching effect.

In the present invention, the chlorine-based liquid bleaching agent composition preferably contains a solvent and more preferably contains water. The content of water in the chlorine-based liquid bleaching agent composition is preferably the rest of the bleaching agent, such as sodium hypochlorite, the surfactant, the alkaline agent, and other components (e.g., the chelating agent, etc.). The content of water in the chlorine-based liquid bleaching agent composition is preferably 80 to 98 mass %, more preferably 88 to 98 mass %, and still more preferably 90 to 98 mass %. When the content of water falls within the foregoing range, excellent storage stability is revealed.

Furthermore, a water-miscible organic solvent may be used as a solvent, and examples thereof include alcohols and ethers.

In the present invention, the chlorine-based liquid bleaching agent composition may be blended with, in addition to the aforementioned components, components, such as a fluorescent dye; a radical scavenger, e.g., BHT (dibutylhydroxytoluene), etc.; a polishing agent or clouding agent, e.g., calcium carbonate, silica, montmorillonite, smectite, etc.; a fragrance, e.g., a terpene alcohol-based fragrance, etc.

### EXAMPLES

The present invention is hereunder described in more detail by way of Examples, which should not be construed as limiting the present invention thereto. Materials, analysis and measurement methods, and production methods of molded product employed in the Examples and Comparative Examples are described below.

### 1. Materials

### [Container]

### <Polyester Resin (A)>

A PET resin (trade name: Unipet BK-2180, manufactured by Nippon Unipet Co., Ltd., intrinsic viscosity=0.83 dL/g; free from a sulfonic acid metal salt group) was used. The resin which had been dried by a dehumidification drier at 150° C. for 8 hours was used.

### <Polyamide Resin (B)>

A 50-L jacketed reactor equipped with a stirrer, a partial condenser, a condenser, a thermometer, a driptank, and a nitrogen gas inlet pipe was charged with 15 kg of adipic acid and 15 g of sodium hypophosphite monohydrate and thoroughly purged with nitrogen; the temperature was increased to 180° C. under a small amount of a nitrogen gas stream to uniformly melt the adipic acid; and thereafter, 13.8 kg of m-xylylenediamine was dropped over 170 minutes while stirring the inside of the system. Meanwhile, the internal temperature was continuously increased to 245° C. Water produced by polycondensation was removed outside the system through the partial condenser and the condenser.

After completion of dropping of m-xylylenediamine, the internal temperature was further increased to 260° C.; the reaction was continued for one hour; and thereafter, a polymer was taken out as a strand from a nozzle in a lower part of the reactor and cooled with water, followed by palletization to obtain a polymer.

Subsequently, the polymer obtained through the aforementioned operations was charged in a 50-L rotary tumbler equipped with a heating jacket, a nitrogen gas inlet pipe, and a vacuum line; and an operation of reducing the pressure of the inside of the system while rotating and then returning to atmospheric pressure using nitrogen having a purity of 99 volume % or more was performed three times. Thereafter, the temperature of the inside of the system was increased to 140° C. under a nitrogen gas stream. Subsequently, the pressure of the inside of the system was reduced; the temperature was further continuously increased to 190° C.; the temperature was kept at 190° C. for 30 minutes; and nitrogen was then introduced to return the pressure of the inside of the system to atmospheric pressure, followed by cooling to obtain a polyamide. The resulting polyamide had a relative viscosity of 2.7.

### <Terminating Reactant>

### Joncryl ADR-4368: Manufactured by BASF SE

### [Chlorine-Based Liquid Bleaching Agent Composition]

Purelox-S (manufactured and sold by Oyalox Co., Ltd., sodium hypochlorite (6 mass %), free from a surfactant, sodium hydroxide: 0.2% or less, pH: 11.7)
Product name: “Daidokoroyo Hyohakuzai (Bleaching Agent for Kitchen)”, selling agency: AEON Co., Ltd (sodium hypochlorite (6 mass %), surfactant (alkylamine oxide), sodium hydroxide, pH: 12 to 13)

### 2. Evaluation Methods

### [Number of Times of Dropping Until Crack Generation]

A 500-mL bottle obtained in each of the Examples as mentioned later was charged with 500 mL of the chlorine-based liquid bleaching agent composition and sealed with a cap for PET bottle, thereby preparing a bleaching agent article before storage. In the Examples and Comparative Examples of “Yes” of the surfactant, the aforementioned “Daidokoroyo Hyohakuzai” was used, and in the Examples of “No” of the surfactant, the aforementioned “Purelox-S” was used. In addition, in the Examples in which the sodium hypochlorite concentration was 2.5 mass %, the aforementioned “Daidokoroyo Hyohakuzai” or “Purelox-S” was used after being properly diluted with pure water.

The aforementioned PET bottle having the chlorine-based liquid bleaching agent composition accommodated therein was stored in a thermostat chamber at 40° C. for 5 months, and the bottle taken out from the thermostat chamber was naturally cooled to room temperature, thereby preparing a bleaching agent article after storage.

The bleaching agent article before and after storage was freely dropped from the bottle bottom from a height of 80 cm towards a concrete floor. Dropping was repeated until a crack of the bottle was confirmed, and the number of times at which the crack was confirmed was recorded. The dropping was carried out while limiting the number of times of dropping to 100 times.

### [Transparency]

The evaluation criteria are as follows.
A: Visibility of the contents is thoroughly revealed.
B: Visibility of the contents is remarkably inferior.

### Examples 1 to 16 and Comparative Examples 3, 4, 7, and 8

Predetermined amounts of the polyester resin (A) and the polyamide resin (B) were weighed and dry-blended; and the blend was charged into a preform injection molding machine (model: SE130DU-CI, manufactured by Sumitomo Heavy Industries, Ltd.) and subjected to injection molding under the following conditions, thereby preparing a single-layer preform.

The single-layer preform molding conditions were as follows.
Mass of one preform: 25 g
Hot runner/cylinder temperature: 285° C.
Hot runner nozzle temperature: 290° C.
Die cooling water temperature: 15° C.
Molding cycle time: 33 sec

Furthermore, the prepared single-layer preform was cooled and then subjected to biaxial stretch blow molding using a blow molding apparatus (model: EFB-1000ET, manufactured by Frontier Inc.) under the following conditions, thereby obtaining a single-layer bottle (height: 223 mm, body diameter: 65 mm, volume: 500 mL, wall thickness: 330 μm, mass: 25.0 g). The die was of a 500-mL petaloid bottom type, and the surface temperature before blow (surface temperature after preform heating) was 107 to 110° C.

The biaxial stretch blow molding conditions are as follows.
Preform heating temperature: 107 to 110° C.
Pressure for stretch rod: 0.5 MPa
Primary blow pressure: 0.5 MPa
Secondary blow pressure: 2.5 MPa
Primary blow delay time: 0.32 sec
Primary blow time: 0.28 sec
Secondary blow time: 2.0 sec
Blow exhaust time: 0.6 sec
Die temperature: 30° C. Using the thus-obtained single-layer bottle, the evaluations were performed based on the aforementioned methods. The results are shown in Tables 1 and 2.

### Comparative Examples 1, 2, 5, and 6

Single-layer bottles were prepared and evaluated in the same manners as in Example 1, except for using only the polyester resin (A). The results are shown in Tables 1 and 2.

### Example 17

A master batch containing the polyester resin (A) and the terminating reactant (Joncryl ADR-4368) in a (polyester resin (A))/(terminating reactant) proportion of 70/30 (mass ratio) was prepared.

A single-layer bottle was prepared and evaluated in the same manners as in Example 1, except for adding 0.1 parts by mass of the aforementioned master batch to 99.9 parts by mass of the sum total of the polyester resin (A) and the polyamide resin (B). The results are shown in Table 2.

TABLE 1

| | | | Example | | | | | | | | Comparative Example | | | |
|---|---|---|---|---|---|---|---|---|---|---|---|---|---|---|
| | | | 1 | 2 | 3 | 4 | 5 | 6 | 7 | 8 | 1 | 2 | 3 | 4 |
| Container | Polyester resin (A) | | 99 | 97 | 95 | 93 | 99 | 97 | 95 | 93 | 100 | 100 | 99.7 | 85 |
| composition | (wt %) | | | | | | | | | | | | | |
| | Polyamide resin (B) | | 1 | 3 | 5 | 7 | 1 | 3 | 5 | 7 | 0 | 0 | 0.3 | 15 |
| | (wt %) | | | | | | | | | | | | | |
| | Terminating reactant | | — | — | — | — | — | — | — | — | — | — | — | — |
| | (wt %) | | | | | | | | | | | | | |
| Liquid | Sodium hypochlorite | | 2.5 | 2.5 | 2.5 | 2.5 | 2.5 | 2.5 | 2.5 | 2.5 | 2.5 | 2.5 | 2.5 | 2.5 |
| bleaching | concentration (wt %) | | | | | | | | | | | | | |
| agent | Presence or absence of | | No | No | No | No | Yes | Yes | Yes | Yes | No | Yes | No | No |
| composition | surfactant | | | | | | | | | | | | | |
| Transparency | | | A | A | A | A | A | A | A | A | A | A | A | B |
| Drop test | Number of | Before | >100 | >100 | >100 | >100 | >100 | >100 | >100 | >100 | >100 | >100 | >100 | >100 |
| | times of | storage | | | | | | | | | | | | |
| | dropping | (times) | | | | | | | | | | | | |
| | until crack | After | 52 | >100 | >100 | >100 | 21 | 68 | >100 | >100 | 12 | 0 | 15 | >100 |
| | generation | storage | | | | | | | | | | | | |
| | | (times) | | | | | | | | | | | | |

TABLE 2

| | | | Example | | | | | | | | | Comparative Example | | | |
|---|---|---|---|---|---|---|---|---|---|---|---|---|---|---|---|
| | | | 9 | 10 | 11 | 12 | 13 | 14 | 15 | 16 | 17 | 5 | 6 | 7 | 8 |
| Container | Polyester resin (A) | | 99 | 97 | 95 | 93 | 99 | 97 | 95 | 93 | 96.97 | 100 | 100 | 99.7 | 85 |
| com- | (wt %) | | | | | | | | | | | | | | |
| position | Polyamide resin (B) | | 1 | 3 | 5 | 7 | 1 | 3 | 5 | 7 | 3 | 0 | 0 | 0.3 | 15 |
| | (wt %) | | | | | | | | | | | | | | |
| | Terminating reactant | | — | — | — | — | — | — | — | — | 0.03 | — | — | — | — |
| | (wt %) | | | | | | | | | | | | | | |
| Liquid | Sodium hypochlorite | | 6 | 6 | 6 | 6 | 6 | 6 | 6 | 6 | 6 | 6 | 6 | 6 | 6 |
| bleaching | concentration | | | | | | | | | | | | | | |
| agent | (wt %) | | | | | | | | | | | | | | |
| com- | Presence or | | No | No | No | No | Yes | Yes | Yes | Yes | Yes | No | Yes | No | No |
| position | absence of | | | | | | | | | | | | | | |
| | surfactant | | | | | | | | | | | | | | |
| Transparency | | | A | A | A | A | A | A | A | A | A | A | A | A | B |
| Drop test | Number of | Before | >100 | >100 | >100 | >100 | >100 | >100 | >100 | >100 | >100 | >100 | >100 | >100 | >100 |
| | times of | storage | | | | | | | | | | | | | |
| | dropping | (times) | | | | | | | | | | | | | |
| | until crack | After | 34 | 89 | >100 | >100 | 13 | 46 | >100 | >100 | 53 | 5 | 0 | 6 | >100 |
| | generation | storage | | | | | | | | | | | | | |
| | | (times) | | | | | | | | | | | | | |

In accordance with Tables 1 and 2, in comparison with Comparative Examples 1, 2, 5, and 6 not containing the polyamide resin (B) and Comparative Examples 3 and 7 in which the content of the polyamide resin (B) is low, in Examples 1 to 17 satisfying the constituent features of the present invention, it was noted that the number of times of dropping until crack generation is large, and even in the case of accommodating the chlorine-based liquid bleaching agent composition, the generation of a crack is suppressed, and the ESCR is improved. In addition, in Comparative Examples 4 and 8 in which the content of the polyamide resin (B) is high, it was noted that though the drop test is excellent, the transparency is inferior.

1. A container for chlorine-based liquid bleaching agent composition comprising 90 to 99.5 parts by mass of a polyester resin (A) and 0.5 to 10 parts by mass of a polyamide (B) (a sum total of the polyester resin (A) and the polyamide resin (B) is 100 parts by mass),
wherein the polyester resin (A) has a structural unit derived from a dicarboxylic acid and a structural unit derived from a diol, 80 mol % or more of the structural unit derived from a dicarboxylic acid being a structural unit derived from terephthalic acid, and 80 mol % or more of the structural unit derived from a diol being a structural unit derived from ethylene glycol; and
the polyamide resin (B) has a structural unit derived from a diamine and a structural unit derived from a dicarboxylic acid, 80 mol % or more of the structural unit derived from a diamine being a structural unit derived from xylylenediamine, and 80 mol % or more of the structural unit derived from a dicarboxylic acid being a structural unit derived from adipic acid.

2. The container for chlorine-based liquid bleaching agent composition according to claim 1, wherein the chlorine-based liquid bleaching agent composition comprises 0.5 to 15 mass % of sodium hypochlorite.

3. The container for chlorine-based liquid bleaching agent composition according to claim 1, wherein the chlorine-based liquid bleaching agent composition comprises a surfactant.

4. The container for chlorine-based liquid bleaching agent composition according to claim 1, wherein the chlorine-based liquid bleaching agent composition comprises an alkaline agent.

5. The container for chlorine-based liquid bleaching agent composition according to claim 1, wherein the container further comprises an epoxy-functional polymer (C) including a styrene unit represented by the following formula (c1) and a glycidyl (meth)acrylate unit represented by the following formula (c2): 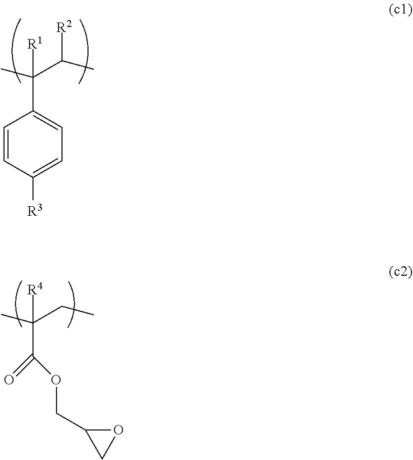
wherein R¹ to R⁴ each independently represent a hydrogen atom or an alkyl group having 1 to 12 carbon atoms.

6. The container for chlorine-based liquid bleaching agent composition according to claim 1, wherein the container is a single-layer container.

7. A bleaching agent article comprising a container having a chlorine-based liquid bleaching agent composition accommodated therein,
the container comprising 90 to 99.5 parts by mass of a polyester resin (A) and 0.5 to 10 parts by mass of a polyamide (B) (a sum total of the polyester resin (A) and the polyamide resin (B) is 100 parts by mass),
wherein the polyester resin (A) has a structural unit derived from a dicarboxylic acid and a structural unit derived from a diol, 80 mol % or more of the structural unit derived from a dicarboxylic acid being a structural unit derived from terephthalic acid, and 80 mol % or more of the structural unit derived from a diol being a structural unit derived from ethylene glycol; and
the polyamide resin (B) has a structural unit derived from a diamine and a structural unit derived from a dicarboxylic acid, 80 mol % or more of the structural unit derived from a diamine being a structural unit derived from xylylenediamine, and 80 mol % or more of the structural unit derived from a dicarboxylic acid being a structural unit derived from adipic acid.

8. The bleaching agent article according to claim 7, wherein the chlorine-based liquid bleaching agent composition comprises 0.5 to 15 mass % of sodium hypochlorite.

9. The bleaching agent article according to claim 7, wherein the chlorine-based liquid bleaching agent composition comprises a surfactant.

10. The bleaching agent article according to claim 7, wherein the chlorine-based liquid bleaching agent composition comprises an alkaline agent.

11. The bleaching agent article according to claim 7, wherein the container further comprises an epoxy-functional polymer (C) including a styrene unit represented by the following formula (c1) and a glycidyl (meth)acrylate unit represented by the following formula (c2): 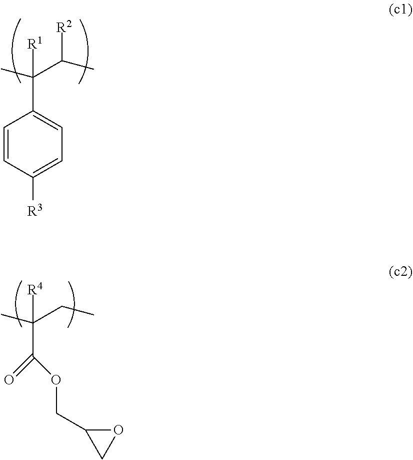
wherein R¹ to R⁴ each independently represent a hydrogen atom or an alkyl group having 1 to 12 carbon atoms.

12. The bleaching agent article according to claim 7, wherein the container is a single-layer container.
